(19) United States
(12) Patent Application Publication
(10) Pub. No.: US 2005/0149744 A1
(43) Pub. Date: Jul. 7, 2005

(54) Network processor having cryptographic processing including an authentication buffer

(75) Inventors: Jaroslaw Sydir, San Jose, CA (US); Kamal J. Koshy, Milpitas, CA (US); Wajdi Feghali, Boston, MA (US); Bradley A. Burres, Cambridge, MA (US); Gilbert M. Wolrich, Framingham, MA (US)

Correspondence Address: Daly, Crowley & Mofford, LLP;c/o PortfolioIP, P.O. Box 52050, Minneapolis, MN, 55402, US

(73) Assignee: Intel Corporation

(21) Appl. No.: 10/749,913

(22) Filed: Dec. 29, 2003

(51) Int. Cl. H04L 9/32

(52) U.S. Cl. 713/189

(57) ABSTRACT

A network processing having cryptographic processing includes an authentication buffer for storing ciphered data and providing the ciphered data to an authentication core.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The present disclosure relates generally to network processors and, more particularly, to network processors having cryptographic data processing.

### BACKGROUND OF THE INVENTION

As is known in the art, there is a trend to provide network processors that perform cryptographic processing of packet data. To facilitate cryptographic processing, network processors include cryptographic acceleration units (also referred to as “crypto units”). The crypto units accelerate the cryptographic processing of packet data to support cryptographic processing at line rate. One example of a network processor including such a crypto unit is the Intel IXP2850 network processor manufactured by Intel Corporation of Santa Clara, Calif.

Two types of cryptographic processing that are commonly performed on packet data are authentication processing (or more simply authentication) and ciphering processing (or more simply ciphering). Authentication is the process of creating a digest of the packet, which is sent along with the packet, to allow the receiver to verify that the packet was indeed sent by the sender (rather than by some third party) and was not modified in transit. Ciphering is the process of encrypting the packet, so that only the intended receiver, with the correct cryptographic key, can decrypt the packet and read its contents. Most commonly used security protocols perform both ciphering and authentication on each packet.

The crypto units in the Intel IXP2850 network processor, for example, implement the well-known 3DES/DES (Data Encryption Standard) and AES (Advanced Encryption Standard) cipher algorithms, as well as the SHA1 (Secure Hash Algorithm) authentication algorithm. Each of the crypto units contains a pair of 3DES/DES, and SHA1 cores and a single AES core. By implementing a pair of cores, the crypto units meet the data rate requirements by allowing both cores to process data in parallel, thereby doubling the data rate of a single core.

It is known in the art that common security protocols such as IPSEC (IP Security) and SSL (Secure Socket Layer) require that packet data be subject to ciphering and/or authentication operations. The order in which the ciphering and authentication operations are performed depends upon the protocol and on whether the packet is being encrypted or decrypted. In order to perform cryptographic processing at relatively high data rates, the crypto units perform both the cipher and authentication operations in one pass when both operations are required. Packet data is moved to the crypto unit and the unit is instructed which algorithms to use and whether authentication should be performed before or after ciphering. It is further known that part of the packet data is subject only to authentication processing and that the length of this data may not be a multiple of the block size of the cipher algorithms used to cipher the data.

However, where the crypto units cipher and then authenticate data, the cipher and authentication processing rates may not match so that the amount of time to cipher a block of data may be different than the amount of time to authenticate that block of data. In addition, the block sizes of the cipher and authentication algorithms can be different. For example, an authentication algorithm may process data in 64 byte blocks and a cipher algorithm may process data in 16 byte blocks. In this situation, significant processing overhead may be required to ensure that there is sufficient ciphered data to be authenticated.

It would, therefore, be desirable to overcome the aforesaid and other disadvantages.

### BRIEF DESCRIPTION OF THE DRAWINGS

The disclosure will be more fully understood from the following detailed description taken in conjunction with the accompanying drawings, in which:

FIG. 1 is a pictorial representation of a network processor having cryptographic processing including an authentication buffer in accordance with the present disclosure;

FIG. 2 is a schematic depiction of a crypto unit having an authentication buffer in accordance with the present disclosure;

FIG. 3 is a schematic depiction showing further details of the crypto unit of FIG. 2;

FIG. 4 is a flow diagram showing processing blocks to implement buffering of authentication data in accordance with the present disclosure; and

FIG. 5 is a schematic depiction of a network system having a switching device with a network processor with an authentication buffer in accordance with presently disclosed embodiments.

### DETAILED DESCRIPTION OF THE INVENTION

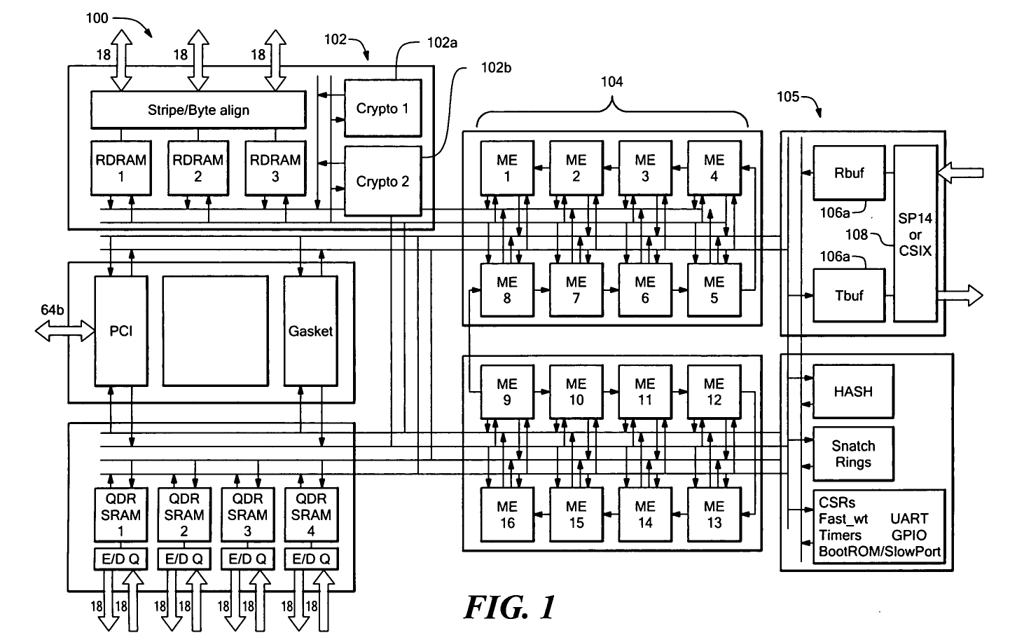

FIG. 1 shows an exemplary network processor 100 having first and second cryptography algorithm hardware acceleration units (crypto units) 102a, 102b for accelerating the cryptographic processing of packet data to support crypto processing at line rate. In general, the crypto units 102 each include an authentication buffer to store ciphered data from cipher cores prior to authentication of the ciphered data so as to abstract the ciphering/authentication processing from a programming standpoint.

Data is moved to the crypto units 102 from one of the microengines (MEs) 104 or from the MSF (Media Switch Fabric) 105, which contains a receive buffer unit 106a and a transmit buffer unit 106b. As is well known to one of ordinary skill in the art, the MEs 104 are programmable packet processing engines that perform security protocol processing, as well as other functions. The crypto units 102 are controlled by software running on the MEs 104. The MSF unit 105 manages the interfaces 108, such as an SPI4 interface, though which packet data enters and exits the network processor 100.

Packet data enters the network processor 100 through one of the supported interfaces and is buffered in the receive buffer unit 106a of the MSF. Software running on the MEs 104 can then read the received data into the MEs, transfer it to memory, and/or transfer it directly to one of the crypto units 102. Packet data is moved into one of the crypto units 102 from either the MSF 105 or from one of the MEs 104. The crypto unit 102 processes the data by performing cipher and/or authentication operations. Processed data is moved back out of the crypto units 102 to the MSF 105 or to one of the MEs 104.

In an exemplary embodiment, the crypto units 102 implement the following cipher algorithms: 3DES, AES, and RC4. The 3DES and AES cipher algorithms are block cipher algorithms, which means that they process data in discrete blocks. The block size of 3DES is 8 bytes and the block size of AES is 16 bytes. RC4 is a stream cipher and processes data one byte at a time.

In one particular embodiment, the crypto units 102 implement the following authentication algorithms: MM5, SHA1, and AES-XCBC-MAC, which are block-oriented algorithms. MD5 and SHA1 have a block size of 64 bytes, while AES-XCBC-MAC has a block size of 16 bytes. Each of the crypto cores contains 4 cipher cores (two 3DES cores, an AES core, and an RC4 core) and 5 authentication cores (two MD5 cores, two SHA1 cores, and an AES-XCBC-MAC core).

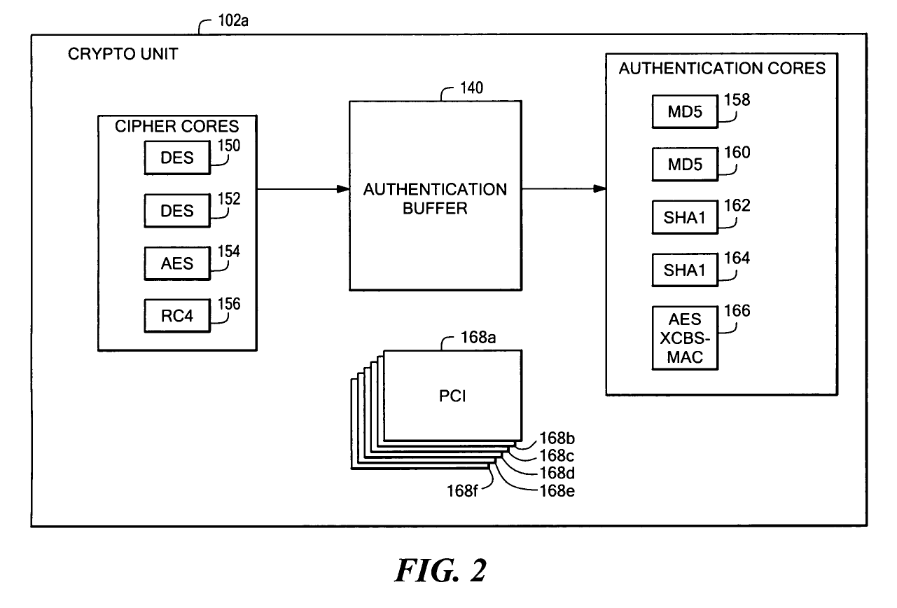

In an exemplary embodiment shown in FIG. 2, the crypto unit 102a has an authentication buffer 140 and a core containing four cipher cores: two 3DES cores 150, 152, an AES core 154, and an RC4 core 156, and five authentication cores: two MD5 cores 158, 160, two SHA1 cores 162, 164, and an AES-XCBC-MAC core 166. In order to support the ciphering of relatively small packets, the crypto units 102 each have six processing contexts 168a-168f, which are each used to process one data packet at a time. Each processing context 168 contains storage for the cipher keys and algorithm context associated with the processing of one packet. The multiple processing contexts 168 allow the latency of loading cryptographic key material and packet data to be hidden by pipelining the loading of data and key material into some of the contexts with the processing of data in other contexts. This allows the crypto unit 102 to achieve close to full utilization of the cipher and authentication cores.

When a packet that requires cryptographic processing arrives, software selects a crypto unit processing context 168 that is not being used to process another packet. Software then loads the cryptographic keys for processing this packet into the selected context and moves packet data for this packet into the crypto unit one block at a time, instructing the unit to process the packet data within the selected context (using the keys that were loaded into the context). The processing of multiple packets (each within its selected context) is performed in parallel within the crypto unit.

In order to maximize ciphering and authentication processing data rates, the crypto unit 102 performs both operations in one pass. Data is moved to the crypto unit 102 with instructions as to which algorithms should be used and whether authentication should be performed before or after ciphering. If authentication is performed after ciphering (on the ciphered data), the crypto unit 102 buffers the data in the authentication buffer 140 after it is ciphered and awaits processing by the given authentication core. If authentication is performed before ciphering or only authentication is performed, packet data enters the authentication buffer directly and awaits processing by the given authentication core.

As described more fully below, when authentication is performed after ciphering, the authentication buffer 140 compensates for the different processing rates of the cipher and authentication cores. In addition, most cipher and authentication algorithms are block-oriented algorithms that process data in discrete blocks of data. In one particular embodiment, the cipher cores 150, 152, 154, 156 process data in 8 or 16 byte blocks while the authentication cores 158, 160, 162, 164, 166 consume blocks of 16 or 64 bytes of data. When an authentication algorithm with a 64 byte block size is used, the cipher core processes multiple 8 or 16 byte blocks until the full 64 bytes of data has been accumulated. The authentication core can then begin processing the data. Similarly, where the block size of the authentication algorithm is 16 bytes and the block size of the cipher algorithm is 8 bytes.

The authentication buffer 140 provides a speed-matching fluction between the cipher and authentication cores. Ciphered data can be written to the authentication buffer 140 at the rate and granularity of the cipher core. Data is read from the authentication buffer 140 by the authentication core at the rate and granularity (block size) of the authentication core. With this arrangement, software is not required to monitor/control the amount of ciphered data ready for authentication. That is, the ciphering/authenticating process is controlled at a packet granularity instead of a data block granularity as is the case in conventional network processor cryptographic processing. When authentication is performed before ciphering or only authentication is performed, the authentication buffer is used to stage data that is to be processed by the authentication core.

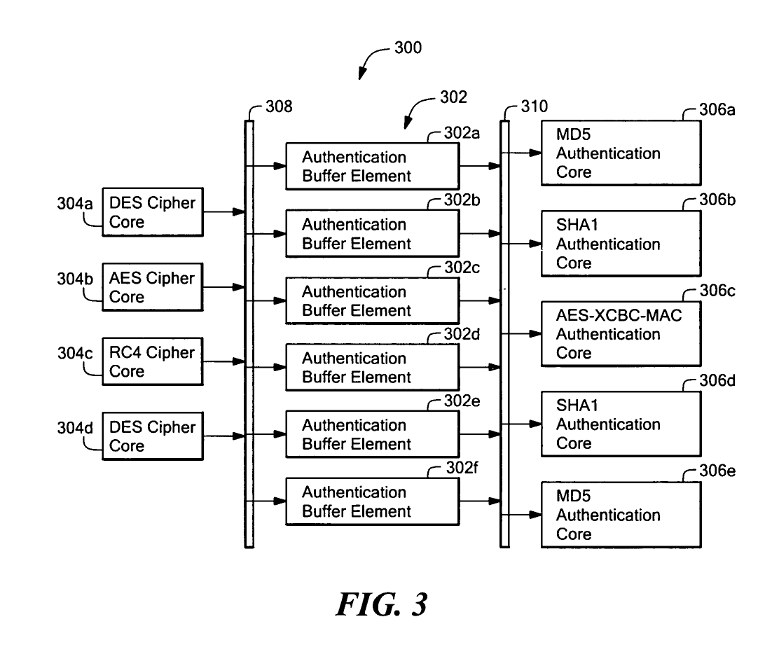

FIG. 3 shows an exemplary crypto unit 300 including an authentication buffer 302 having a buffer element 302a-f for each of the processing contexts. The authentication buffer 302 is shared by the cipher cores 304a-304d and the authentication cores 306a-306e. Associating a buffer element 302a-f with each context allows a programmer to move to the crypto unit data that is destined for the authentication core without worrying about the block size of the authentication core. When ciphering and authentication operations are required, the programmer can cipher blocks of data in a convenient manner and data can accumulate in the authentication buffer 302 until there is enough data for the authentication core to process on a per-context (e.g., packet) basis. When only authentication is performed the programmer can move data into the unit in a convenient manner and data can accumulate in the authentication buffer 302 until there is enough data for the authentication core to process on a per-context (e.g., packet) basis.

In addition, the arrangement in which a separate authentication buffer element is provided for each context decouples operations performed within the processing contexts so as to free a programmer from the task of scheduling the operations of the authentication cores. The program submits the commands required to process a packet (within the assigned context) in the correct sequence without having to coordinate the order in which commands from different contexts are submitted to the crypto unit. This feature is useful, for example, when the crypto units are used to process packet streams from different security protocols, which require different sequences of crypto unit processing.

In an alternative embodiment (not shown), a crypto unit includes an authentication buffer having a buffer element for each of the authentication cores. In this arrangement, a programmer should ensure that sufficient data is ciphered from one context (packet) to allow the authentication core to process a block of data before ciphering data from another context to the same authentication core. Processing of data in different contexts is coordinated so that data from two contexts (packets) does not get written to the same buffer. In this arrangement, software controls the scheduling of the operation of the authentication cores.

It is understood that the cipher cores 304 and authentication cores 306 can be coupled to the authentication buffer elements 302 in a variety of ways including busses and multiplexers. In one particular embodiment, a first set of multiplexers 308 connects the cipher cores 304 to the authentication buffer elements 302 and a second set of multiplexers 310 connects the authentication cores 306 to the authentication buffer elements.

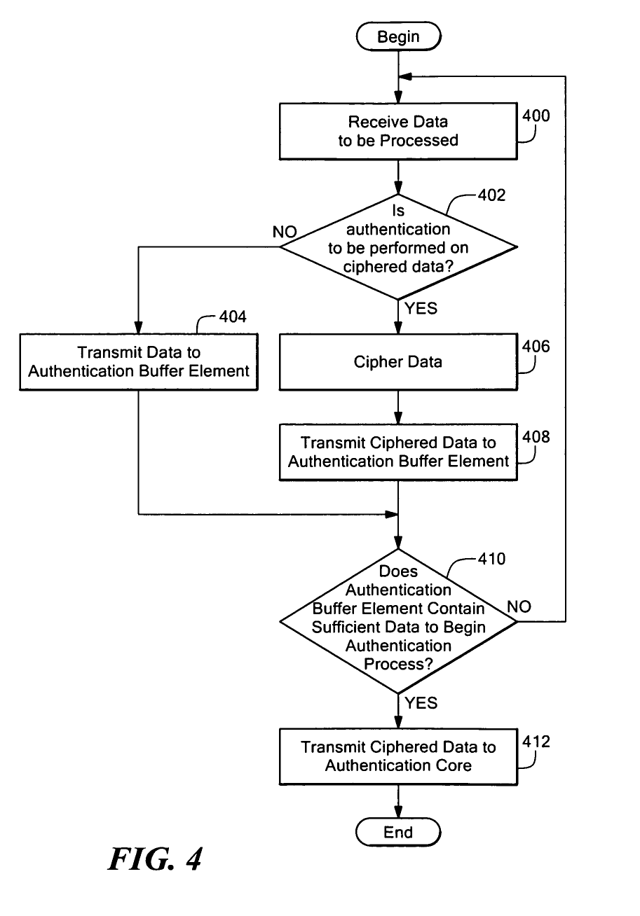

FIG. 4 shows an exemplary sequence of processing blocks for implementing buffering ciphered data for authentication in accordance with the present disclosure. In step 400, the crypto units receive data to be processed. In step 402 it is determined whether the data is to be ciphered before it is moved to the authentication buffer element or moved there directly. If data is to be moved to the authentication buffer element directly, it is moved to the element associated with the current context in step 404. If authentication is to be performed as determined in step 402, in step 406 the cipher cores cipher the data in blocks of predetermined sized base upon the particular cipher algorithm. A given cipher core, for a given processing context (packet), transmits the ciphered data blocks, e.g., 16 byte blocks, to an authentication buffer element corresponding to the current processing context in step 408.

In step 410, it is determined whether the authentication buffer contains sufficient data, e.g., 64 bytes, for an authentication core corresponding to the present processing context to begin processing. If not, the cipher core continues storing blocks of ciphered data in the authentication buffer in step 400. If sufficient data has been stored, in step 412 the authentication core receives the ciphered data transmitted from the authentication buffer and processes the 64 bytes.

By buffering data for authentication processing, significant flexibility is provided from the perspective of the software. The twelve crypto processing contexts (six in each of the crypto units) can be used independently of each other so as to simplify the programming model and reduce the amount of program code required to assign packets to contexts. This decoupling of processing contexts also facilitates the use of different contexts for different types of cryptographic processing. For example, if a network processor is processing both IPSEC (Internet Engineering Task Force (IETF) Proposed Standard for Security Architecture for the Internet Protocol, RFC2401, published November 1998) and SSL (IETF Internet Draft for Secure Socket Layer version 3.0, published 1996) traffic, some of the crypto contexts can be allocated to processing IPSEC and some to processing SSL. It is understood that the code for processing IPSEC and SSL does not have to be related. Another example is that one crypto context can be allocated to performing the authentication and encryption tasks associated with key generation, while the other contexts can be used to perform IPSEC processing.

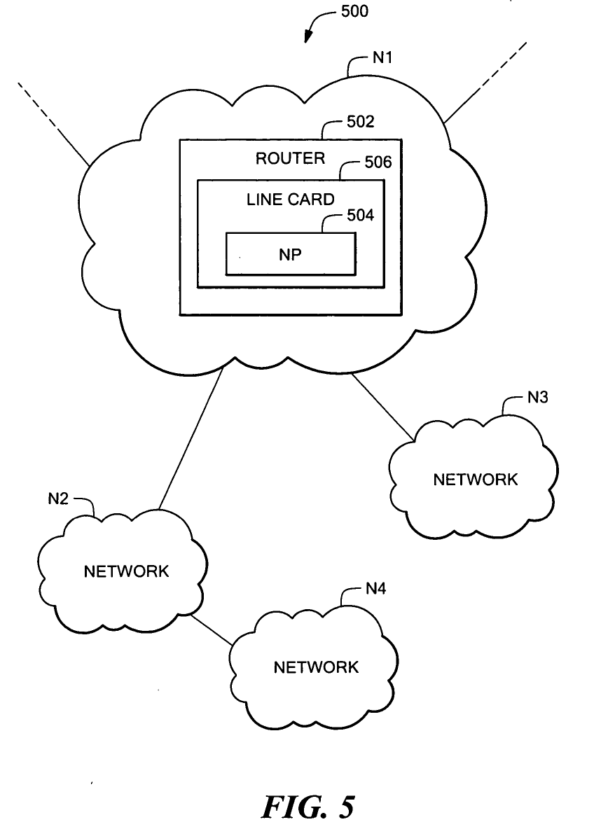

FIG. 5 shows an exemplary system 500 including a first network Ni having a switching device 502 with a network processor 504 containing an authentication buffer as described above. The network processor 504 can form a part of a line card 506 within the switching device 502. The switching device 502 can be coupled to other networks N2, N3, N4 . . . , in a manner well known in the art.

It is understood that the switching device can be provided from a variety of devices that include cryptographic data processing, such as a network router. Various network applications, configurations, switching devices, and topologies for the network and network processor will be readily apparent to one of ordinary skill in the art.

While the embodiments described herein are primarily shown and described in conjunction with an Intel IXP2850 network processor architecture, it is understood that the disclosed embodiments are applicable to network processors in general. For example, it will be appreciated that any number of crypto units can be used without departing from the present embodiments. In addition, the number of cipher cores, authentication, and processing contexts, as well as the supported algorithm types and protocols and block and buffer element sizes can be readily varied without departing from the scope of the present embodiments.

One skilled in the art will appreciate further features and advantages based on the above-described embodiments. Accordingly, the disclosure is not to be limited by what has been particularly shown and described, except as indicated by the appended claims. All publications and references cited herein are expressly incorporated herein by reference in their entirety.

1. A network processor, comprising:
a crypto unit including
a cipher core to cipher data received by the crypto unit;
an authentication core to authenticate the ciphered data; and
an authentication buffer to store the ciphered data and provide the ciphered data to the authentication core in a predetermined amount depending upon an authentication algorithm implemented in the authentication core.

2. The network processor according to claim 1, wherein the crypto unit further includes a plurality of processing contexts.

3. The network processor according to claim 1, wherein the authentication buffer includes a number of buffer elements corresponding to a number of processing contexts.

4. The network processor according to claim 3, wherein each of the buffer elements stores data for a respective one of the processing contexts.

5. The network processor according to claim 1, wherein the buffer elements have a size that is at least as large as a largest authentication algorithm block size.

6. The network processor according to claim 1, wherein the crypto unit includes a plurality of cipher cores, a plurality of authentication cores, and a plurality of authentication buffer elements.

7. The network processor according to claim 6, wherein the plurality of cipher cores are coupled to the authentication buffer elements via a first multiplexer device and the authentication buffer elements are coupled to the plurality of authentication cores via a second multiplexer device.

8. The network processor according to claim 1, wherein the authentication core processes data in 16 byte and/or 64 byte blocks.

9. The network processor according to claim 8, wherein the cipher core processes data in 8 byte and/or 16 byte blocks.

10. A method of cryptographic data processing, comprising:
receiving data at a crypto unit;
storing the received data in blocks having a predetermined size;
storing the data blocks in an authentication buffer until an aggregate size of the stored data blocks is at least a predetermined amount; and
authenticating the data blocks from the authentication buffer upon receipt of the data in the predetermined amount.

11. The method according to claim 10, further including ciphering the received data in a first one of a plurality of cipher cores.

12. The method according to claim 11, further including ciphering data using a first one of a plurality of cipher algorithms.

13. The method according to claim 11, further including authenticating the ciphered data in a plurality of authentication cores.

14. The method according to claim 10, further including authenticating data using a plurality of authentication algorithms.

15. The method according to claim 11, further including storing the ciphered data in a first one of a plurality of buffer elements in the authentication buffer based upon an associated one of a plurality of processing contexts.

16. The method according to claim 11, further including ciphering data in a plurality of cipher cores, storing ciphered data in a first one of a plurality of buffer elements in the authentication buffer based upon an associated one of a plurality of processing contexts, authenticating ciphered data in a plurality of authentication cores, and processing a plurality of packets in parallel.

17. The method according to claim 10, further including determining whether the received data is to be ciphered.

18. A network processor, comprising:
a plurality of cipher cores;
an authentication buffer to stored ciphered data from the plurality of cipher cores, the authentication buffer having a number of buffer elements corresponding to a number of processing contexts, wherein the authentication buffer is coupled to the plurality of cipher cores via a first bus; and
a plurality of authentication cores to authenticate ciphered data from the authentication buffer, wherein the authentication buffer is coupled to the plurality of authentication cores via a second bus.

19. The network processor according to claim 18, wherein a size of at least one of the plurality of buffer elements in the authentication buffer is at least as large as a largest authentication algorithm block size.

20. A network switching device, comprising.
a network processor including a crypto unit having
a cipher core to cipher data received by the crypto unit;
an authentication core to authenticate the ciphered data; and
an authentication buffer to store the ciphered data and provide the ciphered data to the authentication core in a predetermined amount depending upon an authentication algorithm implemented in the authentication core.

21. The device according to claim 20, wherein the crypto unit includes a plurality of processing contexts.

22. The device according to claim 21, wherein the authentication buffer includes a number of buffer elements corresponding to a number of processing contexts.

23. The device according to claim 20, wherein each of the buffer elements stores data for a respective one of the processing contexts.

24. The device according to claim 20, wherein the device includes one or more of a router, network switch, security gateway, storage area network client, and server.

25. A network, comprising.
a network switching device comprising a network processor including a crypto unit having
a cipher core to cipher data received by the crypto unit;
an authentication core to authenticate the ciphered data; and
an authentication buffer to store the ciphered data and provide the ciphered data to the authentication core in a predetermined amount depending upon an authentication algorithm implemented in the authentication core.

26. The network according to claim 25, wherein the crypto unit includes a plurality of processing contexts.

27. The network according to claim 26, wherein the authentication buffer includes a number of buffer elements corresponding to a number of processing contexts.

28. The network according to claim 25, wherein each of the buffer elements stores data for a respective one of the processing contexts.

29. The network according to claim 25, wherein the device includes one or more of a router, network switch, security gateway, storage area network client, and server.
